(19) United States
(12) Patent Application Publication
(10) Pub. No.: US 2026/0346154 A1
(43) Pub. Date: Nov. 5, 2026

(54) EXERCISE DEVICE

(71) Applicant: Arevik Victoria Aramian, Tujunga, CA (US)

(72) Inventor: Arevik Victoria Aramian, Tujunga, CA (US)

(21) Appl. No.: 19/667,432

(22) Filed: May 4, 2026

Related U.S. Application Data
(60) Provisional application No. 63/799,103, filed on May 2, 2025.

(51) Int. Cl. A63H 33/00; A61H 1/02

(52) U.S. Cl. CPC A63H 33/006; A61H 1/0255; A61H 2201/0153; A61H 2201/1253; A61H 2201/1642; A61H 2201/1676; A61H 2201/169

(57) ABSTRACT

The present invention discloses an exercise device, comprising a body with a set of footholds that are adapted to secure the feet of a child. Movements of the body by a user and counteracting resistance forces by the child allows core and lower body of the child to extend and flex, thus providing a range of strength-based active motions by the child that facilitate development of core and lower body muscle and bone strength while relieving potential colic pain.

### CROSS-REFERENCE TO RELATED APPLICATIONS

This Application claims the benefit of priority of co-pending U.S. Utility Provisional Patent Application 63/799,103, filed May 2, 2025, the entire disclosure of which is expressly incorporated by reference in its entirety herein.

All documents mentioned in this specification are herein incorporated by reference to the same extent as if each individual document was specifically and individually indicated to be incorporated by reference.

It should be noted that throughout the disclosure, where a definition or use of a term in any incorporated document(s) is inconsistent or contrary to the definition of that term provided herein, the definition of that term provided herein applies and the definition of that term in the incorporated document(s) does not apply.

### BACKGROUND OF THE INVENTION

### Field of the Invention

One or more embodiments of the present invention relate to an exercise device and more particularly, to an exercise device for development of core and lower body strength for a baby.

### Description of Related Art

Conventional exercise devices for development of lower body strength for a baby are well known and have been in use for a number of years. Non-limiting, non-exhaustive listing of examples of such devices may include Jolly Jumpers, exersaucers, walkers, etc.

Regrettably, most such known devices require that a child to at least have the very basic, rudimentary motor skills before they can use the device. For example, a child should be able to at least sit upright, have the ability to uphold the weight of their head, etc.

Even if a child has sufficiently developed strong erector spinae muscles to sit and strong neck muscles to hold the weight of the head upright, movements performed by a child with insufficient height while using these devices may lead to poor posture in later life. For example, walkers that may have a height that is too high for a shorter height baby, may require the child to tip-toe walk rather than walk with a normal gait, leading to an overall poorer posture.

Accordingly, in light of the current state of the art and the drawbacks to current exercise devices mentioned above, a need exists for an interactive exercise device between an adult and a child for development of core and lower body strength for a baby that would not require the child to sit or to have sufficient strength to hold the weight of their head, while allowing for a full exercise of the core and lower body.

### BRIEF SUMMARY OF THE INVENTION

A non-limiting, exemplary aspect of an embodiment of the present invention provides for an exercise device, comprising:
a body with a set of footholds that are adapted to secure the feet of a child;
wherein: movements of the body by a user and counteracting resistance forces by the child allows core and lower body of the child to extend and flex, thus providing a range of strength-based active motions by the child that facilitate development of core and lower body muscle and bone strength while relieving potential colic pain.

These and other features and aspects of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIGS. 1A to 1F are non-limiting, exemplary illustration of an exercise device in accordance with one or more embodiments of the present invention; and

FIGS. 2A to 2J are non-limiting, exemplary illustrations of an exercise device in accordance with another embodiment of the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

It is to be appreciated that certain features of the invention, which are, for clarity, described in the context of separate embodiments, may also be provided in combination in a single embodiment. Conversely, various features of the invention that are, for brevity, described in the context of a single embodiment may also be provided separately or in any suitable sub-combination or as suitable in any other described embodiment of the invention. Stated otherwise, although the invention is described below in terms of various exemplary embodiments and implementations, it should be understood that the various features and aspects described in one or more of the individual embodiments are not limited in their applicability to the particular embodiment with which they are described, but instead can be applied, alone or in various combinations, to one or more of the other embodiments of the invention.

One or more embodiments of the present invention provide an interactive exercise device between an adult and a child for development of core and lower body strength for a baby that does not require the child to sit nor have sufficient strength to hold the weight of their head, while allowing for a full exercise of the core and lower body.

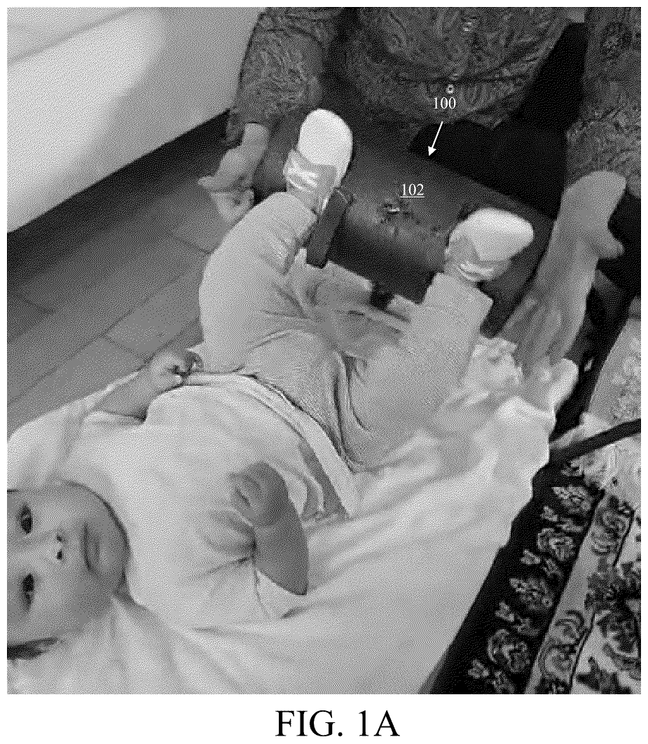

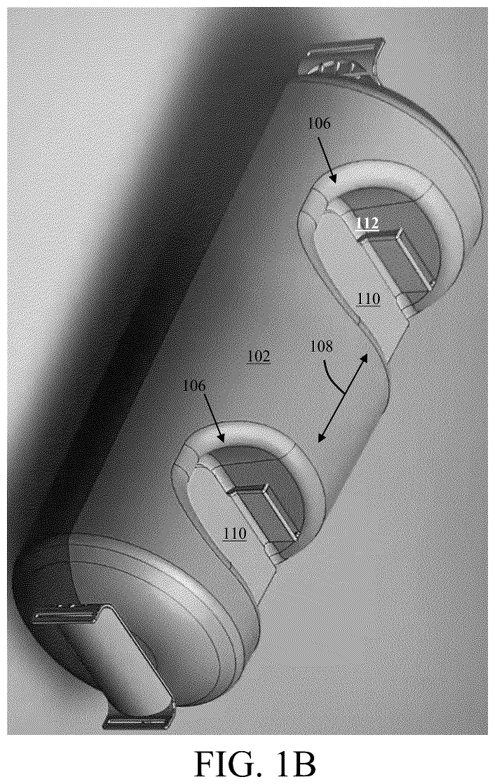

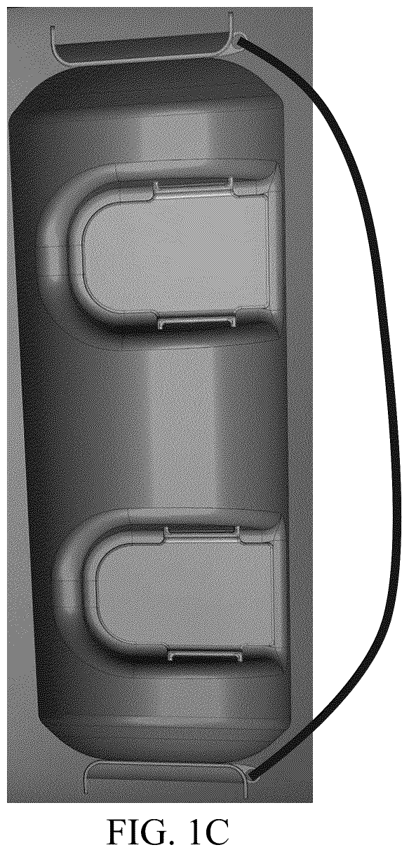

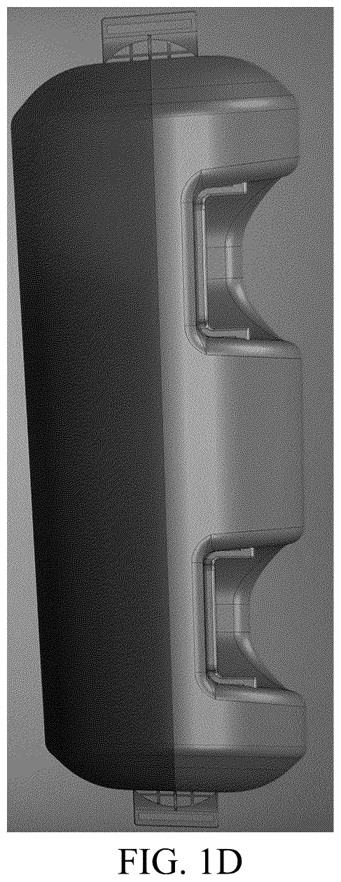

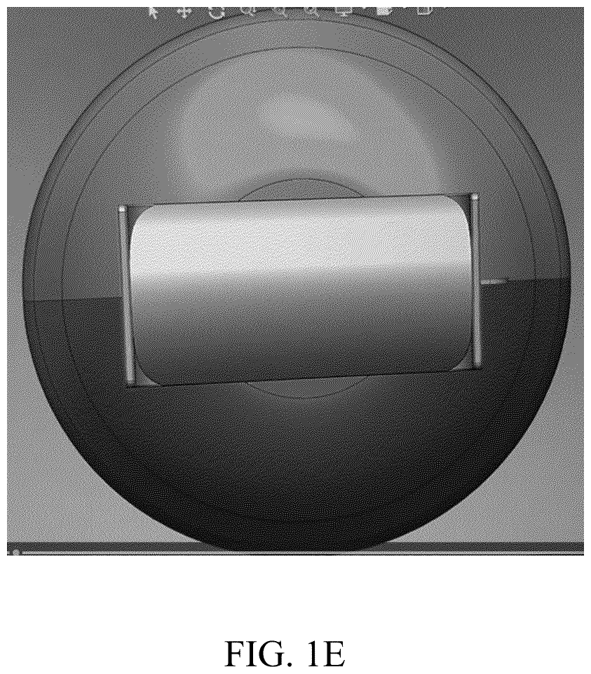

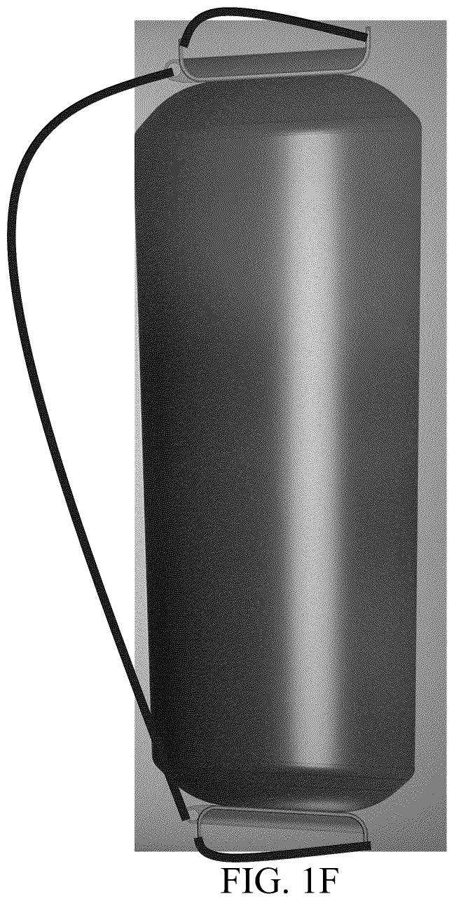

FIGS. 1A to 1F are non-limiting, exemplary illustration of an exercise device in accordance with one or more embodiments of the present invention. As illustrated, the exercise device 100 is comprised of a body 102 with a set of footholds 106 that are adapted to secure the feet of a child while resting in supine position.

Movements of body 102 of exercise device 100 by an adult and counteracting resistance forces by the child allows core and lower body of the child to extend, flex, and move naturally under resistance thus providing a range of strength-based active natural resistance motions by the child that facilitate development of core and lower body muscle and bone strength.

It should be noted that as a positive side effect, since movement of the leg and core muscles also aid in movement of the intestines, such exercises may also relieve intestinal gas, thus potentially relieving any colic pain.

Accordingly, the movement of the device when parents and child are interactive comprises of all ranges of motion with forward and backward movement of the body of the exercise device, allowing the baby to extend and flex their legs in a knee to chest movement, right and left lateral flexion, right rotation and left rotation that can be created with the help of the parents holding the device with applying the desired ranges of motion to help develop muscle and bone strength and can be beneficial for baby's with colicky stomach.

The footholds 106 may be comprised of soft, cushiony straps for securing the feet of the child to the body of the exercise device. Alternatively, and as illustrated, the footholds 106 may also be comprised of recessed portions (or wells or footwells 112) to accommodate the feet. The wells 112 may include soft rubbery sole 110 within for added comfort to accommodate barefoot use by the child.

In the non-limiting, exemplary embodiment, the exercise device 100 is illustrated as a cylindrical form with foot wells that the child's feet are strapped into while the child is supine.

The body 102 of the exercise device 100 can take any shape so long as it is sufficiently light and allows for a set of footholds. For example, the shape of the body of the exercise device can take the form of a cylinder as shown, or other generally elongated geometric shapes such as those with various polygonal cross-sectional profiles, etc. As other examples, the shape of the body of the exercise device can take the form of a cartoon characters, animals, or plants, etc.

The footholds 106 may be separated by a distance that is generally proportional to the average hip and shoulder width sizes of an average child. The number of footholds may be greater than two. For example, three or four footholds will allow the same natural motion of legs/core muscles while the legs are in abducted position when the child's feet are secured to the distal end wells.

The material from which the body of the exercise device is formed may be rigid or soft and cushiony so long as the overall weight of the exercise device is sufficiently light to allow movement thereof by an infant. For example, the material may be comprised of rigid polymers or some soft, plush stuffed configuration (e.g., plush stuffed animal or plush toy) with footholds.

Further, various electronics/lightings may also be added to the body of the exercise device, including housing within to accommodate the electronics and batteries. Other various mechanical devices or other smaller toys such as bells, jingle bells, etc. may also be added to the body of the exercise device. For example, adding a bell may encourage the baby to move as the bell will ring each time the exercise device is moved by the baby.

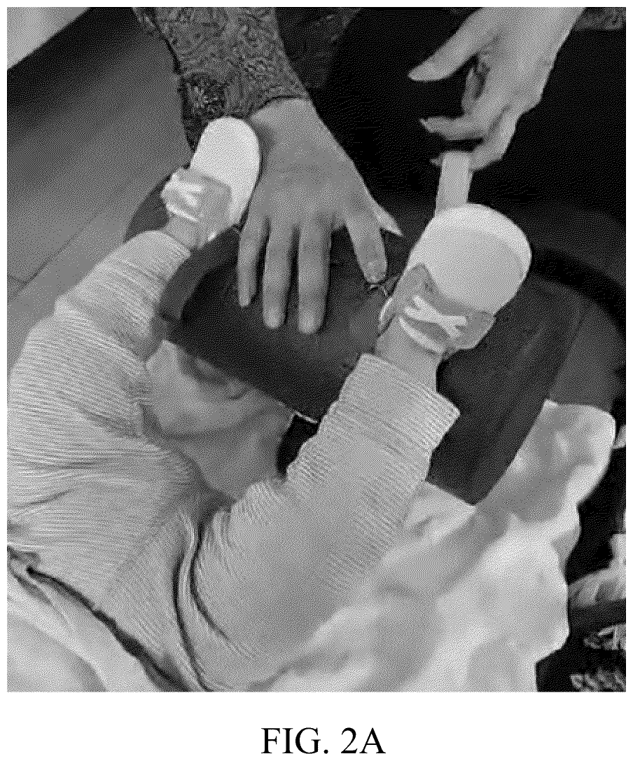

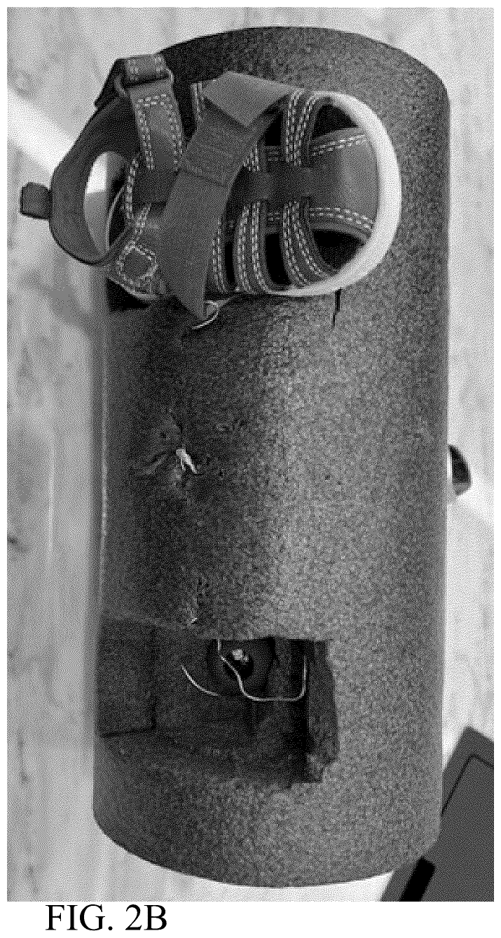

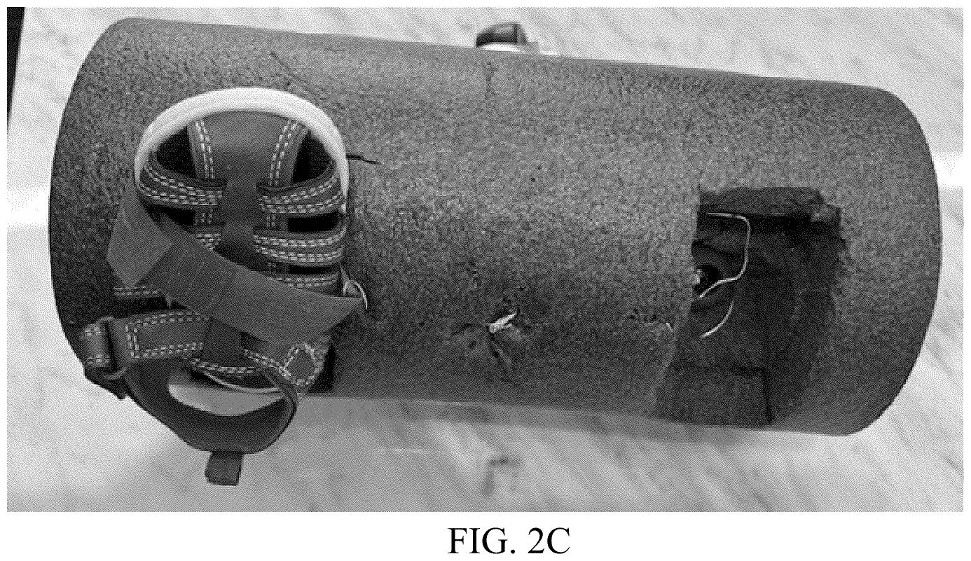

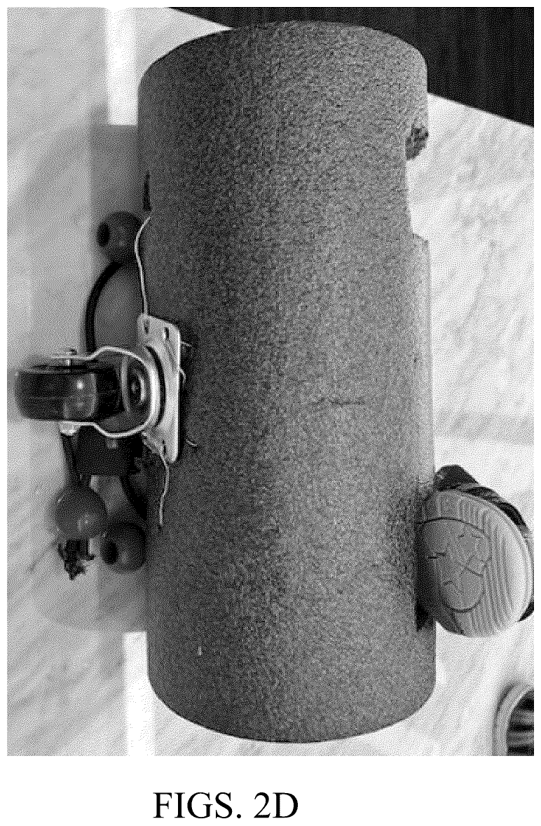

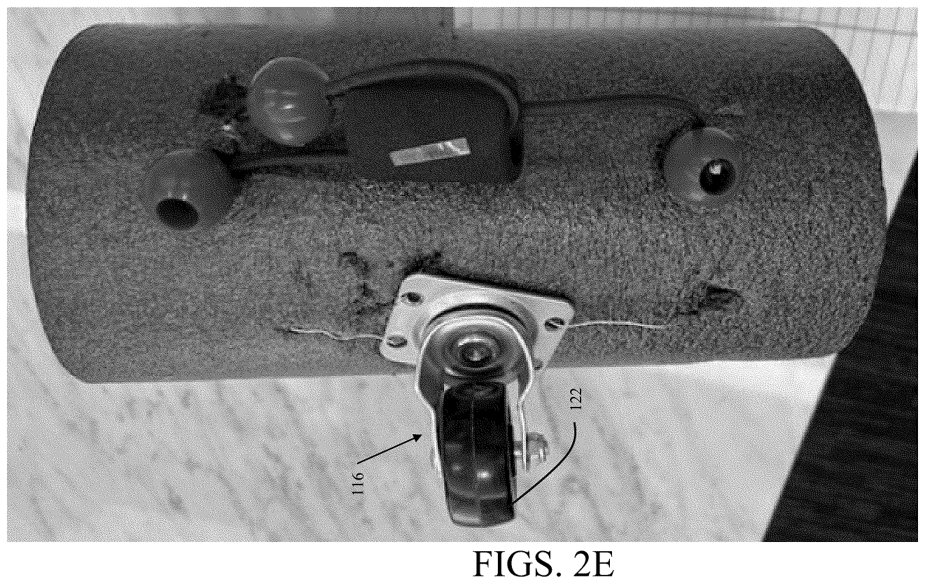

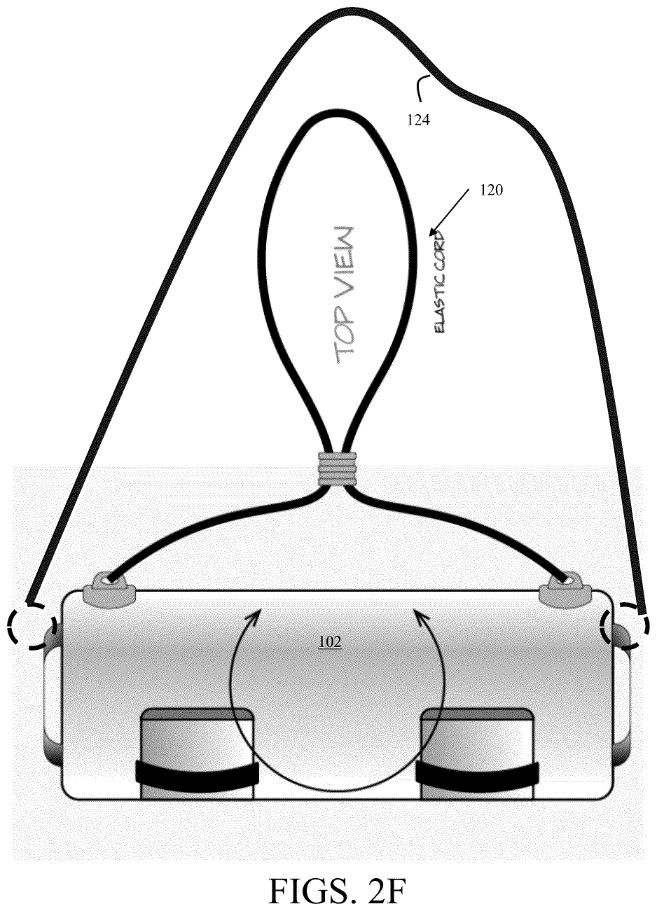

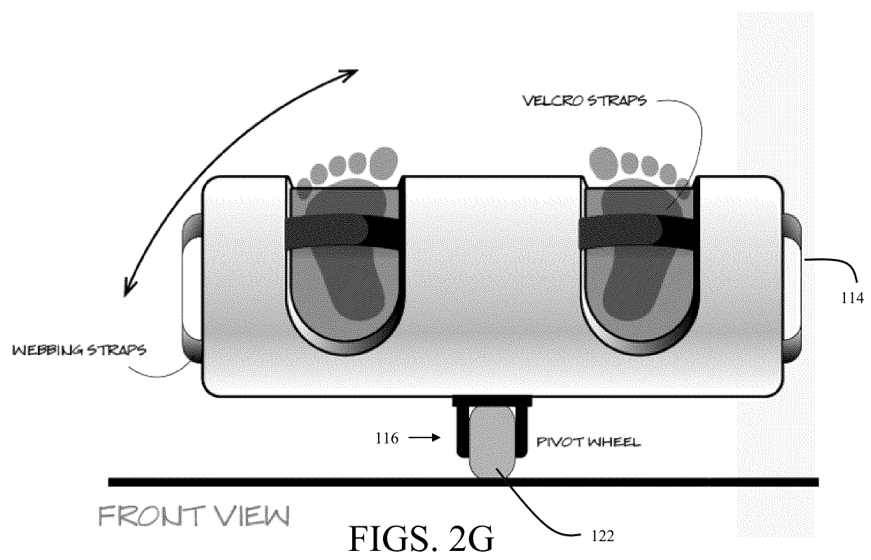

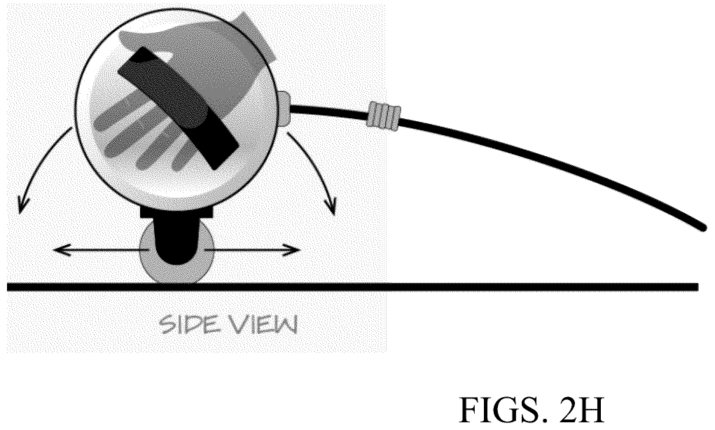

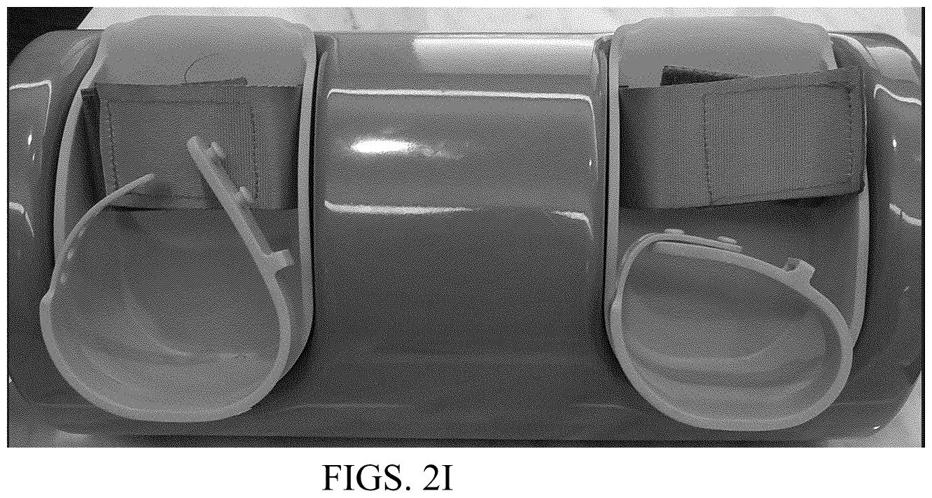

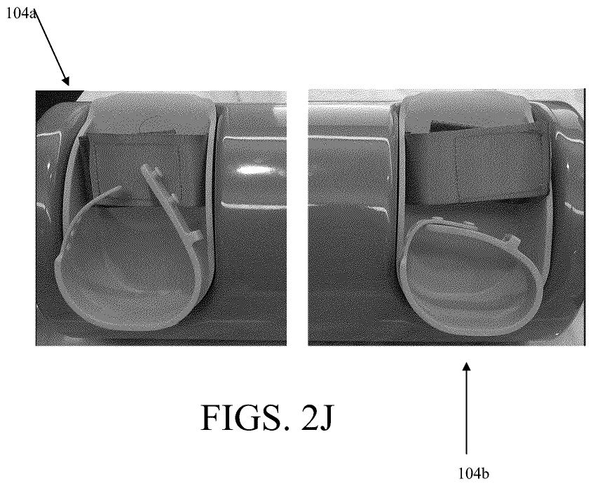

As further illustrated, in this embodiment, strap/handles are included where an adult's hands can be inserted into on both sides (best shown in FIGS. 1F, 2G, and 2H), allowing the adult to hold the exercise device while participating and encouraging the movement of the child's core and lower body.

As best illustrated in FIGS. 1C, 1F, and 2F, optionally, carrying securing mechanisms 124 may be added adjacent the right and left handles 114 to allow for a removable shoulder strap to easily carry the exercise device for travel.

The position of the handles 114 and carrying securing mechanisms, including the type of handles, or carrying securing mechanism being used may be varied. For example, the handles may comprise of strap webbing or be rigid and detachably connected to the body of the exercise device or be an integral part of the body of the exercise device.

FIGS. 2A to 2J are non-limiting, exemplary illustrations of an exercise device in accordance with another embodiment of the present invention. The exercise device illustrated in FIGS. 2A to 2J includes similar corresponding or equivalent components, methods, interconnections, functional, operational, and or cooperative relationships as the exercise device that is shown in FIGS. 1A to 1F, and described above. Therefore, for the sake of brevity, clarity, convenience, and to avoid duplication, the general description of FIGS. 2A to 2J will not repeat every corresponding or equivalent component, methods, interconnections, functional, operational, and or cooperative relationships that has already been described above in relation to exercise device that is shown in FIGS. 1A to 1F but instead, are incorporated by reference herein.

In this non-limiting, exemplary embodiment, the exercise device further includes a wheel assembly 116 detachably associated with the rigid portion of the body of the exercise device.

Further included is an elastic cord 120 associated with the body 102 of the exercise device and wrapped around or worn by the adult. The body of the exercise device may be moved with the aid of the wheel by the child while the elastic cord is adapted to be associated with (or tethered to) the body of the adult.

The wheel allows for development of the core, legs, and feet while the child continues to balance the body of the exercise device on the single wheel. A single wheel on the bottom of the exercise device allows the child to move their legs back and forth while the device is off balance to develop leg strength and balance.

This also frees the hands of the adult to perform other tasks while still adjacent the baby with the device tethered to the adult. In this non-limiting, exemplary embodiment the wheel assembly is a pivot wheel. It should be noted that the device without the wheel (FIG. 1) compels greater interaction with an adult as the adult must hold up the body of the exercise device during use.

As illustrated, the wheel assembly may be attached at the bottom center of the device, allowing the child to roll the device while moving their legs back and forth while off balance to encourage leg strength and balance.

It should be noted that the elastic cord may be used by an adult to pull the cord to create forward movement for extension while the child may create a backward movement to create flexion ranges of motion.

The elastic cord may also be held in adult's hand to have the adult to interact with the baby directly or could also be attached directly to a limb of an adult, allowing the baby to play freely and safely on their own while being supine, forcing the device toward the adult's body and back toward their abdomen (creating a knee to chest movement).

The baby will be playing by pushing and pulling the device with the help of the attached bungee cord safely while their feet are strapped inside the well towards and away from their abdomen, creating a flexion and extension movement.

In this embodiment, the footwells 112 further include both foot straps and ankle straps to better secure a child's feet.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Further, the specification is not confined to the disclosed embodiments. Therefore, while exemplary illustrative embodiments of the invention have been described, numerous variations and alternative embodiments will occur to those skilled in the art. For example, the body of the exercise device may be comprised of two pieces 104a and 104b (FIG. 2J) with each piece having at least a single foothold. It should be noted that a single piece body is preferred as the interaction between the adult and the child will be more controlled and thus, safer. Such variations and alternate embodiments are contemplated, and can be made without departing from the spirit and scope of the invention.

It should further be noted that throughout the entire disclosure, the labels such as left, right, front, back, top, inside, outside, bottom, forward, reverse, clockwise, counter clockwise, up, down, or other similar terms such as upper, lower, aft, fore, vertical, horizontal, lateral, oblique, proximal, distal, parallel, perpendicular, transverse, longitudinal, etc. have been used for convenience purposes only and are not intended to imply any particular fixed direction, orientation, or position. Instead, they are used to reflect relative locations/positions and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

Further the terms “a” and “an” throughout the disclosure (and in particular, claims) do not denote a limitation of quantity, but rather denote the presence of at least one of the referenced item.

The use of the phrases “and or,” “and/or” throughout the specification (if any used) indicate an inclusive “or” where for example, A and or B should be interpreted as “A,” “B,” or both “A and B.”

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. An exercise device, comprising:
a body with a set of footholds that are adapted to secure the feet of a child;
wherein: movements of the body by a user and counteracting resistance forces by the child allows core and lower body of the child to extend and flex, thus providing a range of strength-based active motions by the child that facilitate development of core and lower body muscle and bone strength while relieving potential colic pain.

2. The exercise device, as set forth in claim 1, wherein:
the body is comprised of two pieces with each piece and having at least a single foothold.

3. The exercise device, as set forth in claim 1, wherein:
a material from which the body is formed is rigid.

4. The exercise device, as set forth in claim 1, wherein:
a material from which the body is formed is soft and cushiony.

5. The exercise device, as set forth in claim 1, wherein:
the footholds are comprised of:
soft, cushiony straps for securing the feet of the child to the body of the exercise device.

6. The exercise device, as set forth in claim 1, wherein:
the footholds are separated by a distance that is generally proportional to the average hip and shoulder width sizes of an average child.

7. The exercise device, as set forth in claim 1, wherein:
the footholds are comprised of soft rubbery soles within foot wells.

8. The exercise device, as set forth in claim 1, further comprising:
handles for holding and moving the body.

9. The exercise device, as set forth in claim 1, further comprising:
a wheel assembly detachably associated with the body of the exercise device; and
an elastic cord associated with the body of the exercise device;
wherein: the body of the exercise device is moved with the aid of the wheel by the child while the elastic cord is adapted to be associated with a body of an adult.

10. The exercise device, as set forth in claim 9, wherein:
the wheel is a pivot wheel.
